(19) United States
(12) Patent Application Publication
(10) Pub. No.: US 2018/0169895 A1
(43) Pub. Date: Jun. 21, 2018

(54) HATSCHEK PROCESS

(71) Applicants: Eternit NV, Kapelle-op-den-Bos (BE); Etex Services NV, Kapelle-op-den-Bos (BE)

(72) Inventors: Bertrand Van Acoleyen, Kapelle-op-den-Bos (BE); Etienne Dehombreux, Rebecq (BE); Paul Jacobs, Forest (BE)

(21) Appl. No.: 15/738,337

(22) PCT Filed: Jun. 20, 2016
(86) PCT No.: PCT/EP2016/064202

§ 371 Date: Dec. 20, 2017

(30) Foreign Application Priority Data
Jun. 29, 2015 (BE) BE2015/5399

(51) Int. Cl. B28B 1/52; B28B 13/02

(52) U.S. Cl. CPC B28B 1/527; B28B 13/02

(57) ABSTRACT

A Hatschek machine for the manufacture of fibre cement sheets is provided, comprising at least three rotatable sieve cylinders which are suitable for rotating in a bath, filled with fibre cement slurry, wherein liquid flows from the slurry through the sieve, and wherein a thin layer of fibre cement remains on the sieve, characterized by the presence of at least two baths, at least two sieve cylinders are rotatably mounted in one and the same bath, and each bath has a separate feed line to supply fibre cement slurry into the bath.

### TECHNICAL FIELD

The present invention relates to Hatschek processes and machines, known for the manufacture of fibre cement products.

### STATE OF THE ART

Hatschek processes and machines are widespread and known. They are widely used for the manufacture of fibre cement products. One of the problems with fibre cement products, manufactured according to an Hatschek process on an Hatschek machine, is the layer adhesion, especially for products that comprise lightweight fillers, in addition to cement and fibres, in particular cellulose fibres.

### SUMMARY OF THE INVENTION

It is an object of the invention to produce fibre cement products with a better layer adhesion.

Surprisingly, it was found that one of the causes of inferior layer adhesion is caused by the arrangement of the series of rotating sieves of the Hatschek machine.

A Hatschek machine typically comprises three or four rotatable sieve cylinders which are suitable for rotating in a bath, filled with fibre cement slurry, wherein liquid flows from the slurry through the sieve, and wherein a thin layer of fibre cement remains on the sieve. These fibre cement layers are picked up from the rotary sieves as a stack of layers by an endless felt. Said felts transports the stack of layers to the rotating forming drum where, on the surface of said drum, the layers are accumulated.

Typically, each sieve has its own bath in which it performs a circular motion, or rotates. The fresh fibre cement slurry is fed to the bath that is located furthest away from the forming drum in the direction of movement of the felt. There is supplied so much fresh fibre cement slurry, that the bath is overflowing to the next bath with the following rotating sieve positioned therein. This overflow is the whole or a part of the feed slurry of the second bath, to which optionally extra fresh feed slurry is supplied. A fibre cement layer is again formed on the second sieve, and the second bath subsequently flows over into the next bath. This continues up to and including the last sieve and bath. The overflow from the last bath is collected and recycled in the process.

The baths are connected in cascade, as it is called.

Once the thickness of accumulated fibre layers on the forming drum is large enough, the product of the forming drum is removed as a fresh (“green”) fibre cement sheet. The sheet is cut to size, optionally pressed, and cured, either in the air, or in an autoclave.

It is essential that the initial fibre cement layers adhere well to one another after curing. If this is not the case, the cured sheet will lose its strength.

It has now been found that an alternative arrangement of feed of the baths leads to an improved layer adhesion in the cured sheet.

According to a first aspect of the invention, there is provided a Hatschek machine for the manufacture of fibre cement sheets. Said machine comprises at least three rotatable sieve cylinders which are suitable for rotating in a bath, filled with fibre cement slurry, wherein liquid flows from the slurry through the sieve, and wherein a thin layer of fibre cement remains on the sieve, characterized by the presence of at least two baths, at least two sieve cylinders are rotatably mounted in one and the same bath, and each bath has a separate feed line to supply fibre cement slurry into the bath.

According to some embodiments, the machine may comprise an even number N of rotatable sieve cylinders N and N/2 baths, wherein in each case two rotatable sieve cylinders are mounted in one and the same bath.

According to some embodiments, N may be equal to 4.

According to some embodiments, the machine may comprise an odd number of rotatable sieve cylinders N+1 and (N/2)+1 baths, wherein for N rotatable sieve cylinders in each case two rotatable sieve cylinders are mounted in one and the same bath, and one rotatable sieve cylinder is mounted only in one bath. According to some embodiments, N may be equal to 2 or 4.

In other words, preferably, the rotating sieves are mounted two by two in the same bath. The baths do not overflow into each other, but are each fed with fresh fibre cement slurry via suitable supply lines.

The advantage of this setup is that the various layers of fibre cement which remain on each of the sieves, and are stacked on each other on a conveyor web, according to the known Hatschek method, which in turn delivers the stacks of webs to the forming drum, differ little from one another in composition. In this manner, a much more intense adhesion is achieved between the webs, such that the integrity of the final product, and in particular the layer adhesion, is greatly improved.

Due to the arrangement according to the present invention, for example, the concentration of lightweight fillers or cellulose fibres will not vary, for example, increase with the distance from the fibre cement slurry feed in the process. This is the case for baths (also called tubs) which are arranged in “cascade”.

The advantage with respect to the individual feeding of each bath, with in each bath only one rotating sieve, is that with the arrangement according to the invention, the control of the machine is greatly simplified. This is the case because about half of the control parameters is eliminated.

According to some embodiments, the machine may further comprise a decanter unit.

According to some embodiments, the machine may further include a premixing unit, which is intended for making cement slurry that is to be fed to the baths, wherein each of the baths may obtain fibre cement slurry directly from said premixing unit.

According to some embodiments, the premixing unit may comprise a mixing container, which is intended for mixing different flows of material, and/or which may comprise a filter machine for filtering out coarse solids components from the material flows or the formed mixture.

According to some embodiments, each bath may have an overflow, and a means for at least partially conveying the overflowing liquid to the decanter unit and/or, optionally, to the premixing unit.

According to some embodiments, the machine may have a means for conveying the liquid that has passed through the sieves, at least partly to the decanter unit and/or, optionally, to the premixing unit.

According to some embodiments, each bath may be provided with a liquid level meter.

This liquid level meter, may, for example, be a float, an ultrasonic meter, a radar-based machine, or any other known meter. According to some embodiments, the liquid level meter may include a bubble tube. Said bubble tube is also sometimes called bubble tube or bubble pipe. The bubble tube comprises a tube, for example a steel tube, which is mounted in the bath such that one end is located at a known depth D with respect to the rim of the bath. Via a compressed air supply, air is supplied to the other end of the tube. The pressure which is required to push air bubbles through the tube into the bath, and thus to overcome the hydrostatic pressure in the slurry, is measured. Hence, said measured pressure is the hydrostatic pressure of the slurry height that is present above the end of the tube. Thus, by using said value for the hydrostatic pressure, the height of the slurry above the end of the tube can be determined. The height of the slurry in the bath is than equal to the depth at which the first end of the tube is located, plus the measured slurry height, measured via the hydrostatic pressure.

The optionally changing density during production, which, in theory, also produces changing hydrostatic pressure at a known slurry height, is not necessarily taken into account when determining the height of the slurry in the bath.

From the measured hydrostatic pressure and the corresponding converted slurry height in the bath, a control signal is generated, which controls the supply valves, which valves control the supply of fresh slurry to the bath.

According to a second aspect, the use of a Hatschek machine is provided according to the first aspect of the invention, for the manufacture of fibre cement sheets.

The independent and dependent claims provide specific and preferred features of the embodiments of the invention. Features of the dependent claims may be combined with features of the independent and dependent claims, and this in any suitable manner as would be evident for a skilled person.

The abovementioned and other features, characteristics, and advantages of the present invention will be elucidated with the help of following exemplary embodiments, optionally in combination with the drawings. The description of these exemplary embodiments is given as clarification, without the intention to limit the scope of the invention. The reference numerals in the following description refer to the drawings.

### BRIEF DESCRIPTION OF THE FIGURES

FIGS. 1 and 2 are a schematic representation of a Hatschek machine and Hatschek process according to the present invention.

FIG. 3 is a schematic detail of a Hatschek machine and Hatschek process according to the present invention

### DESCRIPTION OF EXEMPLARY EMBODIMENTS

The present invention is hereinafter described using specific embodiments. It should be noted that the term “comprising”, such as, for example, used in the claims, should not be construed in a limiting sense, limited to the subsequent elements, features and/or steps. The term “comprising” does not exclude the presence of other elements, features, or steps. Hence, the scope of a wording “an object comprising the elements A and B”, is not limited to an object which contains only the elements A and B. The scope of a wording “ a method comprising the steps A and B”, is not limited to a method which only includes the steps A and B. In the light of the present invention, these wordings only mean that the relevant elements and steps of the invention respectively, are the elements and steps A and B, respectively.

In the following specification reference is made to “an embodiment,” or “the embodiment”. Such reference means that a specific element or feature, described based on this embodiment, is comprised in at least this one embodiment. The occurrence of the terms “in an embodiment” or “in one embodiment” on various locations in this description, however, does not necessarily refer to the same embodiment, although it may refer to the same embodiment.

Furthermore, the properties or features may be combined in any suitable way in one or more embodiments, as would be apparent to the skilled person.

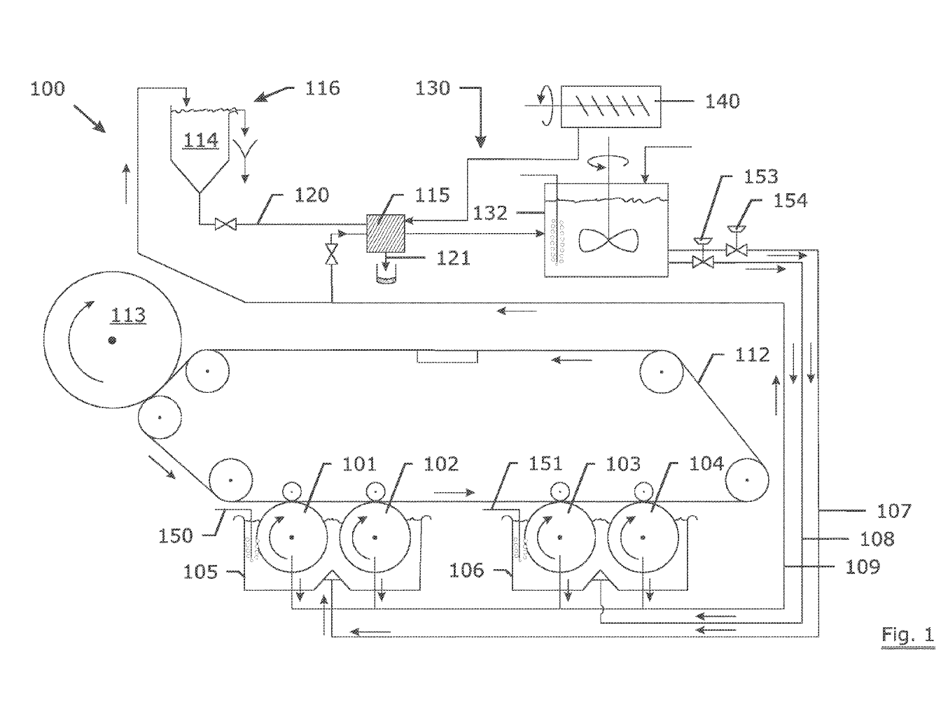

A Hatschek machine 100 for the manufacture of fibre cement sheets is shown in FIG. 1. The machine 100 comprises four rotatable sieve cylinders (101, 102, 103 and 104). Two pairs of sieve cylinders are rotatably mounted in one and the same bath 105, 106, respectively. Each bath has a separate feed line 107, 108, respectively, to supply fibre cement slurry into the bath.

The rotating sieves are suitable for rotating in a bath, filled with fibre cement slurry, wherein liquid flows from the slurry through the sieve, and wherein a thin layer of fibre cement remains on the sieve.

The liquid, mainly water, which flows through the sieves, is collected in a return line 109.

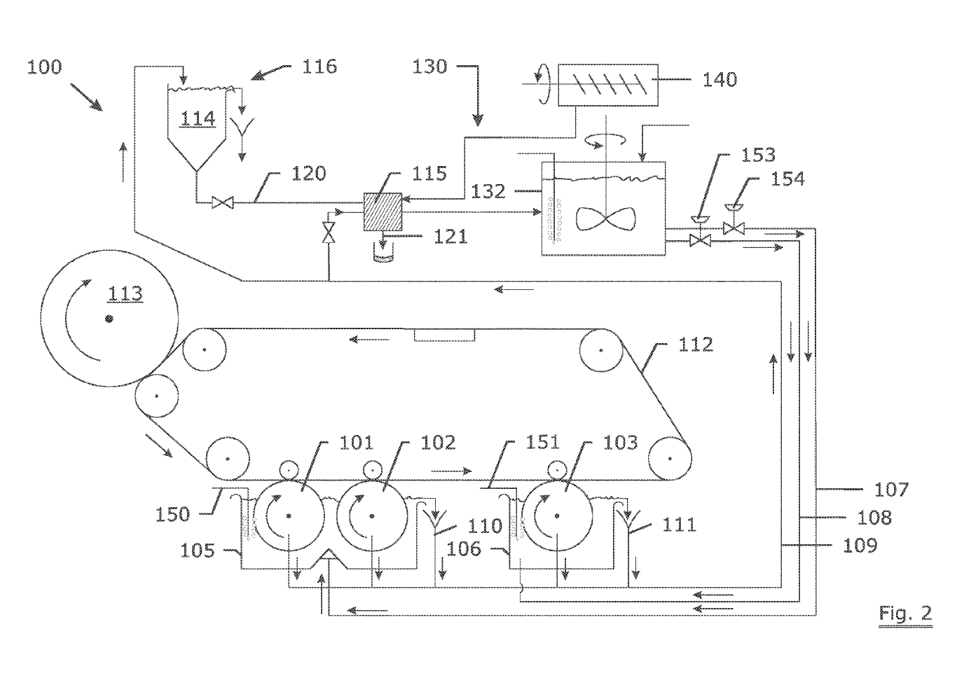

Optionally, as shown in the example in FIG. 2, in the same return line 109, also the overflow 110 and 111 of each of the baths (or “tubs”) is included. In an alternative setting, no overflows are provided and the feed via the feed line and the discharge via the fibre cement web and the water that passes through the sieves are matched.

The thin layers of fibre cement which are retained on the sieves, are picked up by a felt 112 and transported to the forming drum 113, where the layers are accumulated until the desired sheet thickness is obtained.

The Hatschek machine further comprises a decanter unit 114 (also referred to as settling tank or cone). The return line 109 transports a portion of the return water and return slurry to the decanter unit, typically a conical cistern with an internal agitator. Another part of the return line 109 transports return water and return slurry to the filter unit or filter machine 115 (also called selectifier), where it is combined with the sludge line 120 of decanter unit, which provides settled fibre cement slurry. Also fresh fibre cement slurry of the mixing drum 140, optionally process water and the like may be added into said filter unit 115. This filter machine is part of a premixing unit 130. The decanter unit has also an overflow 116, which produces process water that can be reused, for example, to produce the fresh fibre cement slurry.

The filter unit 115 separates hard particles from the input flows via its undercurrent 121. The filtered slurry is supplied 122 to a mixing container 132, to which further additional additives, such as flocculant, are added.

Said mixing container 132 feeds the baths via the feed lines 107 and 108.

Each bath is provided with a liquid level meter, being a bubble tube 150 and 151. The supply of slurry of the mixing bath 132 is controlled via controllable valves 153 and 154 on supply lines 107,108, respectively, which valves are set such that the slurry level in the baths 105, 106, respectively, remains at a certain level

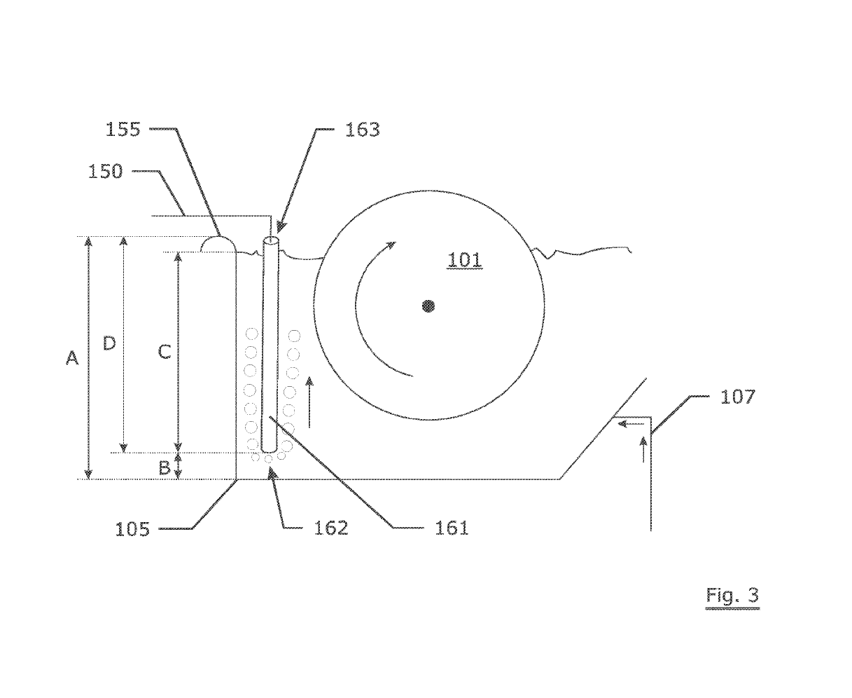

FIG. 3 shows a detail of such a bubble tube 150.

The bubble tube 150 comprises a steel or plastic tube 161 which is mounted in the tub 105 such that one end 162 is located at a known depth D with respect to the rim 155 of the bath. Preferably, the bubble tube is mounted vertically in the bath. Via a compressed air supply 161, air is supplied to the other end 163 of the tube.

The pressure, which is required to push air bubbles through the tube into the bath, and thus to overcome the hydrostatic pressure in the slurry, is measured. Hence, said measured pressure is the hydrostatic pressure of the slurry height C that is present above the end of the tube. Thus, by using said value for the hydrostatic pressure, the height of the slurry C above the end of the tube can be determined. The height of the slurry in the bath is than equal to the distance B of the end 162 to the bottom of the container where the first end of the tube is located, plus the slurry height C, measured via the hydrostatic pressure.

An alternative Hatschek machine 200 for the manufacture of fibre cement sheets is shown in FIG. 2. The machine 200 comprises three rotatable sieve cylinders (101, 102 and 103). One pair of sieve cylinders (101 and 102) is rotatably mounted in one and the same bath 105, the third rotating sieve 103 is mounted in a second bath 106. Each bath has a separate feed line 107, 108, respectively, to supply fibre cement slurry into the bath.

It is clear that, although the embodiments and/or materials for providing embodiments according to the present invention have been discussed, several modifications or changes may be made without departing from the scope and/or gist of this invention.

1. A Hatschek machine for the manufacture of fibre cement sheets, comprising at least three rotatable sieve cylinders which are suitable for rotating in a bath, filled with fibre cement slurry, wherein
liquid flows from the slurry through the sieve,
a thin layer of fibre cement remains on the sieve,
comprising the presence of at least two baths,
at least two sieve cylinders are rotatably mounted in one and the same bath, and
each bath has a separate feed line to supply fibre cement slurry into the bath.

2. A Hatschek machine according to claim 1, wherein the machine comprises an even number of rotatable sieve cylinders N and N/2 baths, and in each case two rotatable sieve cylinders are mounted in one and the same bath.

3. A Hatschek machine according to claim 2, wherein N is equal to 4.

4. A Hatschek machine according to claim 1, wherein the machine comprises an odd number of rotatable sieve cylinders N+1 and (N/2)+1 baths, for N rotatable sieve cylinders in each case two rotatable sieve cylinders are mounted in one and the same bath, and one rotatable sieve cylinder is mounted only in one bath.

5. A Hatschek machine according to claim 4, wherein N is equal to 2 or 4.

6. A Hatschek machine according to claim 1, wherein the machine further comprises a decanter unit.

7. A Hatschek machine according to claim 1, wherein the machine further comprises a premixing unit for producing cement slurry to be fed to the baths, in which each of the baths may obtain fibre cement slurry directly from said premixing unit.

8. A Hatschek machine according to claim 7, wherein the premixing unit comprises a mixing container for mixing different flows of material, and which comprises a filter machine for filtering out coarse solids components from the material flows or the formed mixture.

9. A Hatschek machine according to claim 8, wherein each bath has an overflow, and means for at least partially conveying the overflowing liquid to the decanter unit and/or, optionally, to the premixing unit.

10. A Hatschek machine according to claim 6, wherein the machine has means for conveying the liquid which has passed through the sieves, at least partly to the decanter unit and/or, optionally, to the premixing unit.

11. A Hatschek machine according to claim 1, wherein each bath is provided with a liquid level meter.

12. A Hatschek machine according to claim 11, wherein the liquid level meter comprises a bubble pipe.

13. A method for the manufacture of fibre cement sheets comprising using the Hatschek machine according to claim 1.

14. A Hatschek machine according to claim 5, wherein the machine further comprises a decanter unit.

15. A Hatschek machine according to claim 4, wherein the machine further comprises a decanter unit.

16. A Hatschek machine according to claim 3, wherein the machine further comprises a decanter unit.

17. A Hatschek machine according to claim 2, wherein the machine further comprises a decanter unit.

18. A Hatschek machine according to claim 14, wherein the machine further comprises a premixing unit for producing cement slurry to be fed to the baths, in which each of the baths may obtain fibre cement slurry directly from said premixing unit.

19. A Hatschek machine according to claim 15, wherein the machine further comprises a premixing unit for producing cement slurry to be fed to the baths, in which each of the baths may obtain fibre cement slurry directly from said premixing unit.

20. A Hatschek machine according to claim 16, wherein the machine further comprises a premixing unit for producing cement slurry to be fed to the baths, in which each of the baths may obtain fibre cement slurry directly from said premixing unit.
